(19) United States
(12) Patent Application Publication
(10) Pub. No.: US 2025/0361100 A1
(43) Pub. Date: Nov. 27, 2025

(54) TRANSFER DEVICE, TRANSFER SYSTEM, PROCESSING METHOD, PROCESSING DEVICE, AND STORAGE MEDIUM

(71) Applicant: KABUSHIKI KAISHA TOSHIBA, Tokyo (JP)

(72) Inventors: Kazunobu KONDA, Suginami (JP); Akihito OGAWA, Fujisawa (JP); Harutoshi CHATANI, Yokohama (JP); Kazuma HIRAGURI, Yokohama (JP); Kazuhide SAWA, Kawasaki (JP); Seiji TOKURA, Kawasaki (JP); Yuusuke WADA, Yokohama (JP); Toshio IWASAKI, Tachikawa (JP)

(73) Assignee: KABUSHIKI KAISHA TOSHIBA, Tokyo (JP)

(21) Appl. No.: 19/208,865

(22) Filed: May 15, 2025

(30) Foreign Application Priority Data
May 22, 2024 (JP) 2024-083558

(51) Int. Cl. B65G 47/91; B07C 5/18; B07C 5/36; G06V 20/50; G06V 40/10

(52) U.S. Cl. CPC B65G 47/917; B07C 5/18; B07C 5/36; G06V 20/50; G06V 40/10

(57) ABSTRACT

According to one embodiment, a transfer device includes a collaborative robot, a first sensor, a housing, and a fixture. The collaborative robot is configured to transfer an object. The first sensor is configured to detect the object. To the housing, the collaborative robot and the first sensor are mounted, and the housing is movable by a mobile mechanism. The fixture is mounted to the housing, and is configured to fix the housing.

### CROSS-REFERENCE TO RELATED APPLICATIONS

This application is based upon and claims the benefit of priority from Japanese Patent Application No. 2024-083558, filed on May 22, 2024; the entire contents of which are incorporated herein by reference.

### FIELD

Embodiments of the invention generally relate to a transfer device, a transfer system, a processing method, a processing device, a program, and a storage medium.

### BACKGROUND

Transfer devices, which include industrial robots, are used to transfer objects. There is a need for technology that can introduce a transfer device more easily to a site in which manual work is performed.

### BRIEF DESCRIPTION OF THE DRAWINGS

FIG. 1 is a perspective view showing a transfer device according to an embodiment;

FIG. 2 is a perspective views showing a specific example of a fixture;

FIGS. 3A and 3B are perspective views showing the specific example of the fixture;

FIG. 4 is a perspective view showing the specific example of the fixture;

FIG. 5 is a perspective view showing an application example of the transfer device according to the embodiment;

FIG. 6 is a schematic plan view showing a transfer system according to the embodiment;

FIG. 7 is a schematic plan view showing the transfer system according to the embodiment;

FIG. 8 is a flowchart showing operations of the transfer device according to the embodiment;

FIG. 9 is a schematic view showing a display example of a graphical user interface;

FIG. 10 is a schematic view showing a display example of a graphical user interface;

FIG. 11 is a schematic view showing an example of a gripping tool;

FIG. 12 is a schematic view showing an example of a gripping tool;

FIG. 13 is a schematic view showing an example of a gripping tool; and

FIG. 14 is a schematic view illustrating a hardware configuration.

### DETAILED DESCRIPTION

According to one embodiment, a transfer device includes a collaborative robot, a first sensor, a housing, and a fixture. The collaborative robot is configured to transfer an object. The first sensor is configured to detect the object. To the housing, the collaborative robot and the first sensor are mounted, and the housing is movable by a mobile mechanism. The fixture is mounted to the housing, and is configured to fix the housing.

Embodiments of the invention will now be described with reference to the drawings. The drawings are schematic or conceptual; and the relationships between the thicknesses and widths of portions, the proportions of sizes between portions, etc., are not necessarily the same as the actual values thereof. The dimensions and/or the proportions may be illustrated differently between the drawings, even in the case where the same portion is illustrated. In the drawings and the specification of the application, components similar to those described thereinabove are marked with like reference numerals, and a detailed description is omitted as appropriate.

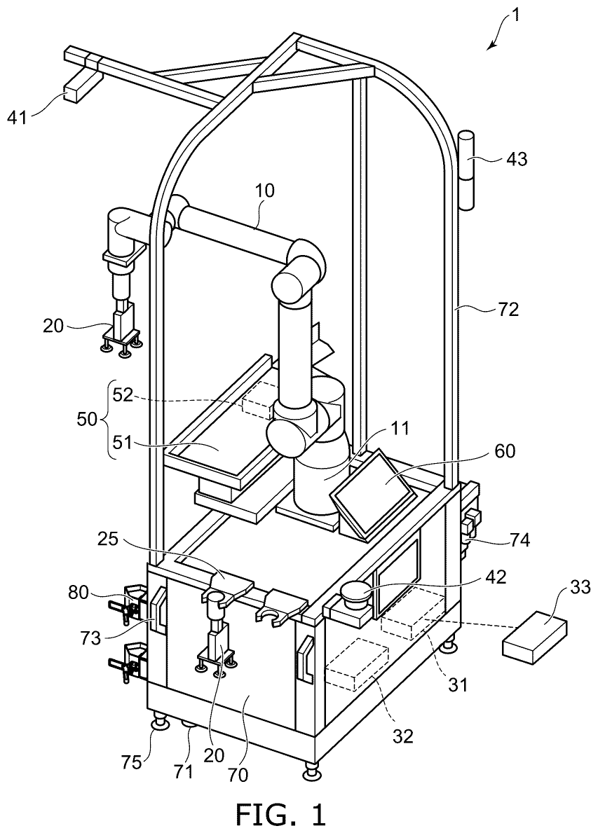

FIG. 1 is a perspective view showing a transfer device according to an embodiment.

As shown in FIG. 1, the transfer device 1 according to the embodiment includes a collaborative robot 10, a gripping tool 20, a tool pocket 25, a control device 31, a robot controller 32, a processing device 33, a first sensor 41, a second sensor 42, a light-emitting device 43, an inspection device 50, a display device 60, a housing 70, and a fixture 80.

The collaborative robot 10 is an articulated robot configured to transfer an object. The collaborative robot 10 grips the object by suction-gripping or pinching, and moves the gripped object. The distal end of the collaborative robot 10 has six or more degrees of freedom. In the illustrated example, the collaborative robot 10 is a vertical articulated robot. The collaborative robot 10 may be a horizontal articulated robot or a parallel link robot. The collaborative robot 10 may include a combination of two or more selected from a vertical articulated robot, a horizontal articulated robot, and a parallel link robot.

The collaborative robot 10 is one type of industrial robot, and is configured to allow work to proceed in cooperation with a person in a work site. The collaborative robot 10 has a built-in safety function that stops the operation when contact with a person is detected. For example, ISO 10218-1, ISO 10218-2, and Technical Specification ISO/TS15066 are established as Machine-Specific Safety Standards (type-C standards) to which collaborative robots and systems including collaborative robots must conform. Industrial robots that conform to these safety standards are classified as “collaborative robots”.

The gripping tool 20 that grips the object is mounted to the distal end of the collaborative robot 10. The collaborative robot 10 uses the gripping tool 20 to grip and transfer the object.

The control device 31 controls the overall system of the transfer device 1. For example, the gripping tool 20 communicates with the components included in the transfer device 1, generates transfer plans, processes information obtained by the sensors, etc.

The robot controller 32 controls operations of the collaborative robot 10. For example, the robot controller 32 operates the collaborative robot 10 according to a transfer plan generated by the control device 31.

The processing device 33 acquires information from another transfer system and/or transmits information to yet another transfer system. According to the embodiment, the processing device 33 is provided to replace information processing that would be performed by a person. The processing device 33 communicates with the control device 31 via wired communication, wireless communication, or a network. The processing device 33 may be located in a location other than the housing 70, or may be housed in the housing 70. A processing device that has the functions of both the control device 31 and the processing device 33 may be located in the housing 70.

The first sensor 41 detects an object transferred by the collaborative robot 10. The control device 31 uses detection results of the first sensor 41 to generate a transfer plan. The first sensor 41 includes at least one selected from an imaging device and a distance sensor. For example, the first sensor 41 is a camera configured to acquire an RGB color image. The first sensor 41 may be configured to acquire a depth image in addition to a color image.

The second sensor 42 detects a person at the periphery of the transfer device 1. When the second sensor 42 detects a person, the robot controller 32 slows the operation of the collaborative robot 10 or stops the operation of the collaborative robot 10. The second sensor 42 includes at least one selected from an imaging device and a distance sensor. For example, the second sensor 42 is a laser scanner that detects persons by scanning a laser beam in the periphery.

The light-emitting device 43 emits a light to notify persons in the surroundings of the presence of the collaborative robot 10. For example, the light-emitting device 43 is a revolving light and emits a red light while rotating.

The inspection device 50 inspects the object transferred by the collaborative robot 10. More specifically, the object to be transferred by the collaborative robot 10 is instructed by another system. The inspection device 50 inspects whether or not the transferred object matches the instructed object. When the transferred object matches the instructed object, the inspection is passed. When the transferred object does not match the instructed object, the inspection is failed.

As an example, the inspection device 50 includes a detection part that detects the weight of the object, and a transfer part that transfers the object transferred by the collaborative robot 10 to a prescribed position. In the illustrated example, a conveyor 51 is included as the transfer part; and a weight sensor 52 is included as the detection part that detects the weight. The object that is transferred by the collaborative robot 10 is placed on the conveyor 51. The conveyor 51 transfers the placed object in a prescribed direction. The weight sensor 52 measures the weight of the object being transferred. The weight sensor 52 compares the measured weight with the weight of the instructed object. When the difference between the measured weight and the weight of the instructed object is less than a threshold, the weight sensor 52 determines that the transferred object matches the instructed object.

The display device 60 displays information related to the transfer device 1. For example, logs of the operation of the collaborative robot 10, inspections by the inspection device 50, etc., are displayed by the display device 60. When the transfer by the collaborative robot 10 is completed, a work completion notification may be displayed by the display device 60. When the transfer by the collaborative robot 10 has failed, the cause of the failure, the procedure to recover from the failure, etc., may be displayed by the display device 60.

The housing 70 is a box-shaped container configured to store the control device 31, the robot controller 32, etc. A base 11, the first sensor 41, the second sensor 42, the light-emitting device 43, the inspection device 50, the display device 60, etc., of the collaborative robot 10 are mounted to the housing 70 and fixed with respect to the housing 70.

Wheels 71 (an example of a mobile mechanism) are mounted to the bottom surface of the housing 70. The housing 70 can move along the floor surface due to rolling of the wheels 71. The wheels 71 are mounted respectively to the four corners of the bottom surface of the housing 70. The part to which the wheels 71 are mounted may be separable from the part to which the collaborative robot 10, the inspection device 50, and the like are fixed. For example, the housing 70 may be configured so that the part to which the collaborative robot 10, the inspection device 50, and the like are fixed is installed on a cart or mobile robot that includes the wheels 71.

In the illustrated example, a frame 72, a handle 73, an air pipe 74, and an adjuster pad 75 also are mounted to the housing 70.

The frame 72 is a rod-shaped member positioned on the housing 70. The frame 72 includes a part extending vertically, and a part extending horizontally. A portion of the frame 72 is positioned above the collaborative robot 10; and the first sensor 41 is mounted to this portion of the frame 72. As a result, the first sensor 41 can detect objects contained in the container from above.

The handle 73 is mounted to the side surface of the housing 70, and is configured to be graspable by a person. By grasping the handle 73 and applying a force to the housing 70 horizontally, the person can move the transfer device 1 by causing the wheels 71 to roll.

The air pipe 74 is included when the collaborative robot 10 grips the object by suction-gripping. The air pipe 74 communicates with the internal space of the gripping tool 20. An external exhaust device can cause the gripping tool 20 to grip or release the object by exhausting or supplying air via the air pipe 74.

The adjuster pads 75 are mounted respectively to the four corners of the bottom surface of the housing 70. The vertical-direction lengths of the adjuster pads 75 are modifiable. Rubber pads are located at the bottom portions of the adjuster pads 75. After the transfer device 1 is moved using the wheels 71, the adjuster pads 75 are extended so that the pads contact the floor surface. As a result, the transfer device 1 can be stably installed on the floor surface.

A tool pocket 25 (a holder) also is mounted to the housing 70. The tool pocket 25 is a member that holds the gripping tool 20. The gripping tool 20 is detachable from the distal end of the collaborative robot 10. The collaborative robot 10 can use an empty tool pocket 25 to detach the gripping tool 20 mounted to the distal end. After detaching the gripping tool 20, the collaborative robot 10 can mount, to the distal end, another gripping tool 20 held by the tool pocket 25.

The fixture 80 is provided to fix the housing 70, and is mounted to the housing 70. The housing 70 is fixed by the fixture 80 being mechanically coupled to a prescribed mating member. Instead of a mechanical coupling, the fixture 80 may be fixed by an electrostatic force or by attraction due to a magnetic force. The fixture 80 may be fixed by attaching to the mating member by suction.

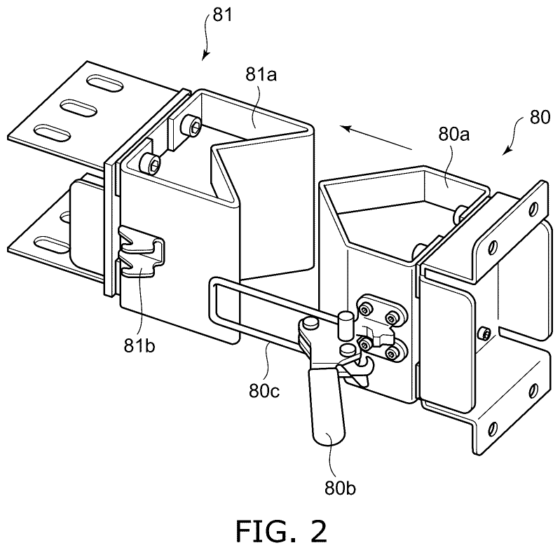

FIGS. 2, 3A, 3B, and 4 are perspective views showing a specific example of the fixture.

The fixture 80 is fixed with respect to a mating member 81 shown in FIG. 2. The fixture 80 includes a convex member 80a, a handle 80b, and a latch 80c.

The convex member 80a is fixed with respect to the side surface of the housing 70 and protrudes sideward of the housing 70. In the illustrated example, the distal end of the convex member 80a is triangular when viewed in plan. The handle 80b is a rod-shaped member to be grasped by a person, and is mounted to the side surface of the convex member 80a. The handle 80b is rotatable horizontally with respect to the convex member 80a. The latch 80c is mounted to the handle 80b and has an opening that is open horizontally. The latch 80c is rotatable horizontally with respect to the handle 80b.

The mating member 81 includes a concave member 81a and a hook part 81b. The concave member 81a is fixed to equipment, a structural component, etc. The distal end of the concave member 81a is recessed to engage with the convex member 80a. The hook part 81b is provided for latching the handle 80b, and is fixed to the side surface of the concave member 81a.

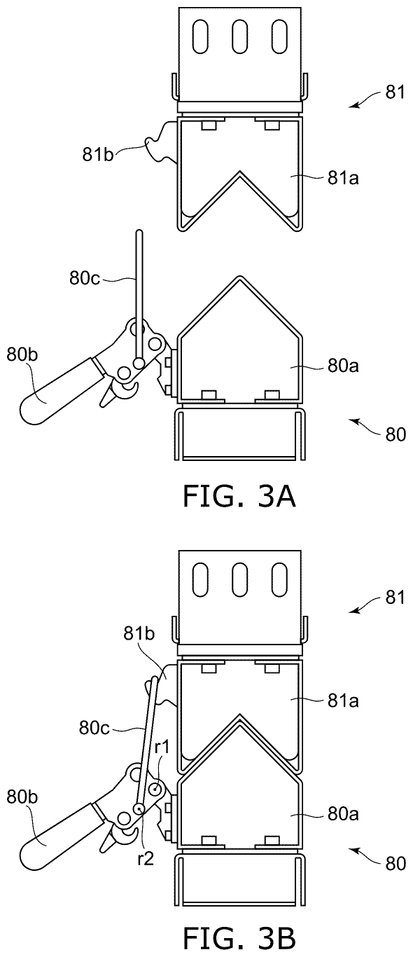

When fixing the transfer device 1, first, the housing 70 is moved to a position so that the convex portion of the convex member 80a faces the concave portion of the concave member 81a as shown in FIG. 3A. Then, the housing 70 is moved toward the mating member 81, and the convex member 80a is caused to engage with the concave member 81a. Continuing as shown in FIG. 3B, the handle 80b is latched on the hook part 81b.

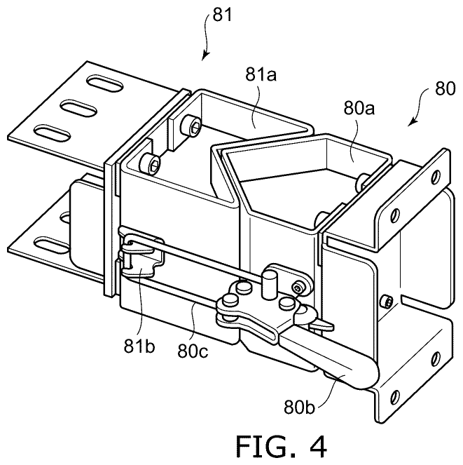

When the handle 80b is rotated from the state of FIG. 3B around a rotation axis r1, the distance increases between the hook part 81b and a rotation axis r2 of the latch 80c. The latch 80c is strongly latched on the hook part 81b, and the fixture 80 is fixed with respect to the mating member 81 as shown in FIG. 4. Wiring (power supply wiring, communication wiring, compressor connection wiring, etc.), which is not illustrated, is connected after fixing the fixture 80.

When the fixture 80 is detached from the mating member 81, the operation described above is performed in reverse. For example, the various wiring is detached, and the transfer device 1 is allowed to move by operating the handle 80b to release the lock between the latch 80c and the hook part 81b.

Although the fixture 80 includes a convex portion and the mating member 81 includes a concave portion in the illustrated example, the shape of the fixture 80 and the shape of the mating member 81 are arbitrary as long as the fixture 80 and the mating member 81 can engage with each other. The fixture 80 may include a concave portion; and the mating member 81 may include a convex portion. The fixture 80 and the mating member 81 each may include a concave portion and a convex portion; and the concave portion and convex portion of the fixture 80 may respectively engage with the convex portion and concave portion of the fixture 80.

The transfer device 1 is applicable to a picking task. In the picking task, a prescribed object is removed from a container in which one or more objects are contained. The removed object is moved to another container or transfer device; and the object is transferred toward another location.

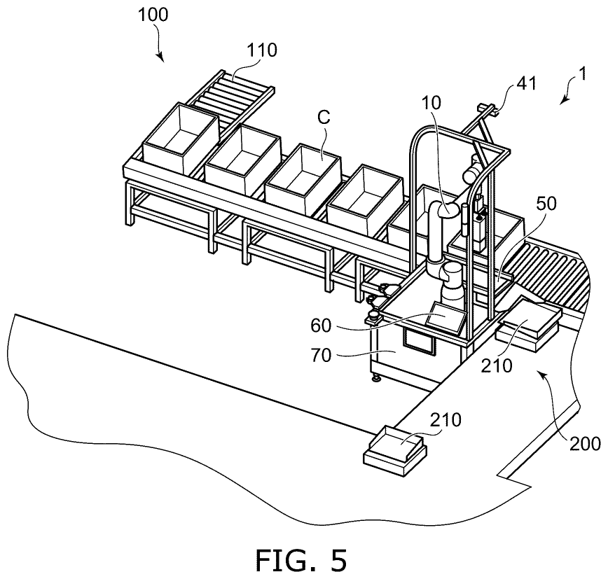

FIG. 5 is a perspective view showing an application example of the transfer device according to the embodiment.

In the example shown in FIG. 5, a first transfer system 100 and a second transfer system 200 are included. The first transfer system 100 includes a conveyor 110. The conveyor 110 transfers a container C in which objects are contained to a position at which the collaborative robot 10 can grip an object. The conveyor 110 is a roller conveyor, a belt conveyor, etc. The collaborative robot 10 removes an object from the container C, and places the object in the inspection device 50. The inspection device 50 inspects the object that is placed. The inspected object is discharged toward a mobile body 210 of the second transfer system 200. The mobile body 210 is a mobile robot that transfers an object. A tray is mounted to the upper surface of the mobile body 210; and the mobile body 210 receives the discharged object in the tray.

The mobile body 210 transfers the object to a prescribed location according to the result of the inspection. Specifically, when the inspection is passed and the instructed number of objects is placed on the tray, the mobile body 210 transfers the objects to the prescribed storage location. When the inspection is failed, the mobile body 210 transfers the object to a container in which objects determined to have failed are collected. The collected objects are subsequently transferred to an appropriate location by a worker.

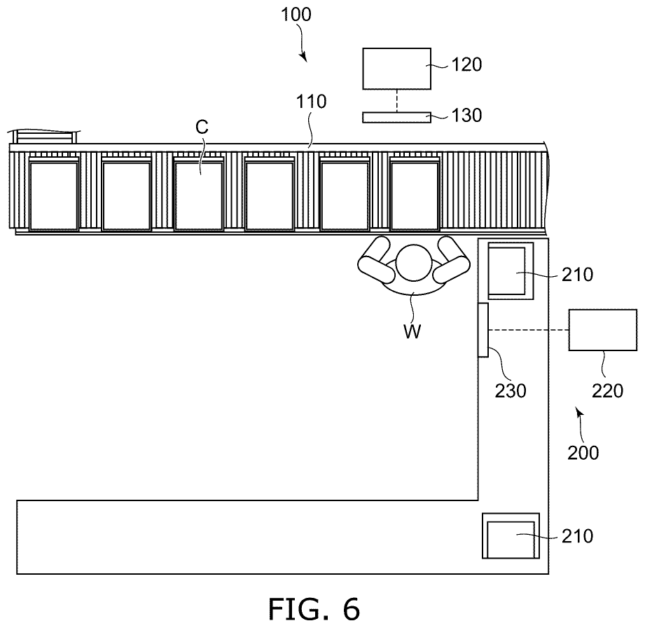

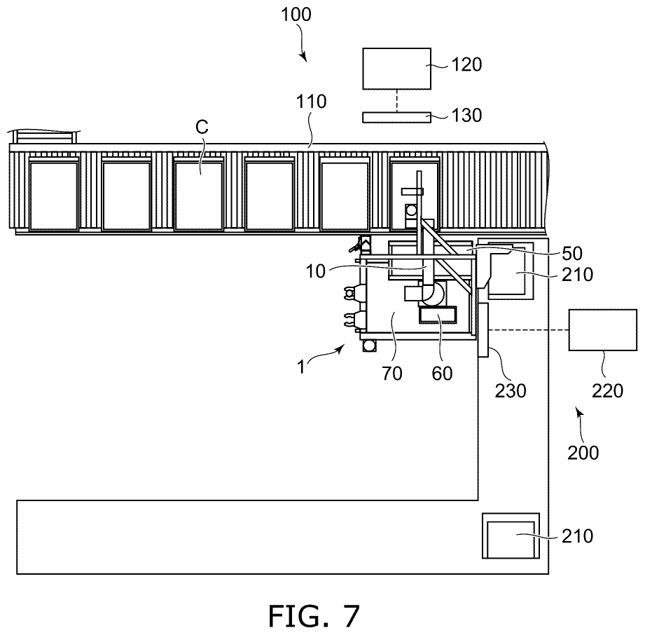

FIGS. 6 and 7 are schematic plan views showing a transfer system according to an embodiment.

The movement of objects from the conveyor 110 to the mobile body 210 may be performed by a person. For example, as shown in FIG. 6, the first transfer system 100 further includes a processing device 120 and a display device 130. The second transfer system 200 further includes a processing device 220 and a display device 230.

The processing device 120 sequentially transfers the multiple containers C to the conveyor 110 based on instructions from a higher-level system. The display device 130 is located proximate to the transfer device 1. The processing device 120 causes the display device 130 to display information of the objects to be removed from the container C. A worker W checks the display device 130 and moves the displayed objects from the container C to the mobile body 210.

When the objects are moved to the mobile body 210, the worker W inputs information of the objects to the processing device 220. For example, the worker reads barcodes of the moved objects with a reader. Identification information of the barcodes that are read is transmitted from the reader to the processing device 220. The information may be input to the processing device 220 using an input device such as a keyboard, a touch panel, etc., instead of a reader. When accepting information of an object, the processing device 220 determines the transfer destination of the object. The processing device 220 instructs the transfer destination to the mobile body 210; and the mobile body 210 transfers the object to the instructed location.

The manual work shown in FIG. 6 can be replaced with the transfer device 1 as shown in FIG. 7. The transfer device 1 reads the information displayed by the display device 130, transfers the objects from the container C to the mobile body 210, inputs information to the processing device 220, etc.

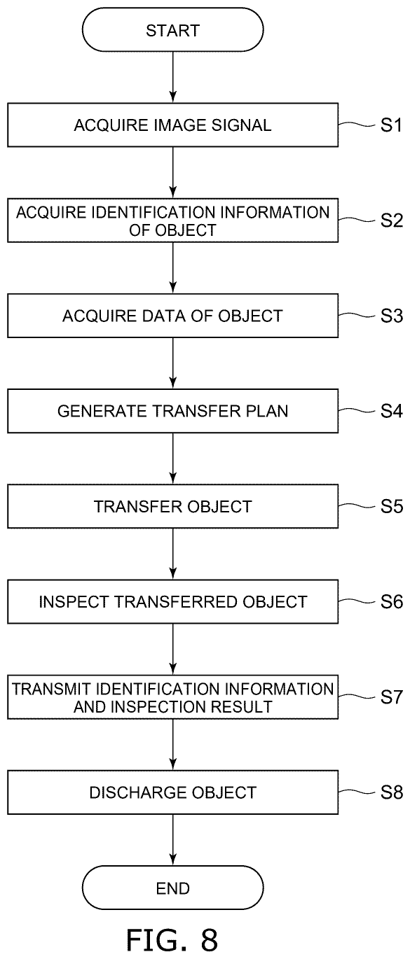

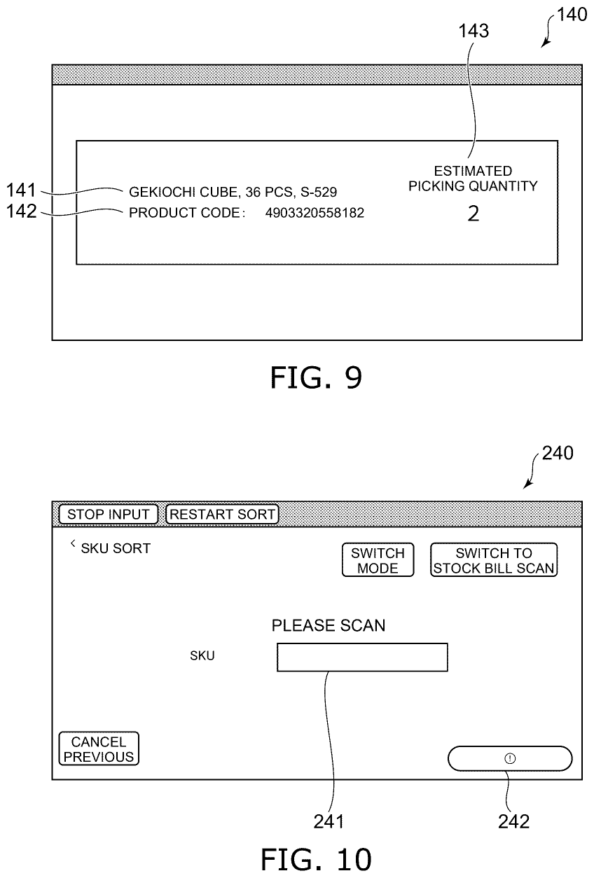

FIG. 8 is a flowchart showing operations of the transfer device according to the embodiment. FIGS. 9 and 10 are schematic views showing display examples of graphical user interfaces.

As one specific example, the operations shown in FIG. 8 are performed when the transfer device 1 performs the work. First, the processing device 33 acquires an image signal transmitted from the processing device 120 to the display device 130 (step S1). The processing device 33 acquires the identification information of the transferred object from the image signal (step S2). Image recognition technology used in robotic process automation (RPA) is applicable to acquire the identification information.

FIG. 9 is an example of a display screen of the display device 130. A GUI 140 shown in FIG. 9 is displayed by the display device 130. The GUI 140 includes a name 141, a product code 142 (identification information), and a quantity 143 related to the transferred object. The name 141 indicates the name of the object. The product code 142 is a unique code assigned to each object. The product code 142 is information for identifying the object. The quantity 143 indicates the number of objects to be transferred.

The processing device 33 uses image recognition to read the product code 142 (the identification information) included in the image signal. The processing device 33 transmits the identification information that is read to the control device 31. The control device 31 uses identification information to acquire more detailed data of the object from a database prepared beforehand (step S3). The data is used to generate a transfer plan, inspect, etc. For example, data such as the weight of the object, the presence of gloss of the object surface, whether or not the shape changes when gripped, the barcode attached to the object, etc., is acquired.

The control device 31 uses the acquired data to generate a transfer plan (step S4). The robot controller 32 transfers the object by operating the collaborative robot 10 according to the generated transfer plan (step S5). After transferring, the inspection device 50 inspects the transferred object by using the data acquired by the control device 31 (step S6). The inspection device 50 transmits the inspection result to the processing device 33. The processing device 33 transmits the identification information and inspection result of the object to the processing device 220 (step S7). The inspection device 50 discharges the inspected object toward the mobile body 210 (step S8).

FIG. 10 is an example of a display screen of the display device 230. A GUI 240 shown in FIG. 10 is displayed by the display device 230. The GUI 240 includes an input field 241 and an icon 242. Information of the barcode of the transferred object is input to the input field 241. After the information is input to the input field 241, the input information is registered by clicking the icon 242. For example, the processing device 33 emulates the operation of an input device. The processing device 33 uses a signal of the emulated input device to transmit the identification information and inspection result of the object to the processing device 220. The processing device 33 inputs the information of the barcode to the input field 241 as the identification information, and clicks the icon 242. The processing device 33 also inputs the inspection result of the object to the processing device 220.

As an example, when the inspection is passed, the processing device 33 inputs the information of the barcode of the transferred object to the input field 241. When the inspection is failed, the processing device 33 inputs a value (e.g., “−1”) to the input field 241 to indicate that the inspection was failed. When the input of the information of the barcode is accepted, the processing device 220 determines that the inspection result was “pass”. The processing device 220 transmits an instruction to the mobile body 210 to transfer the object to a location that is predesignated for the transferred objects. When the input of a value indicating “fail” is accepted, the processing device 220 determines the inspection result to be “fail”. The processing device 220 transmits an instruction to the mobile body 210 to transfer the object to a location that is predesignated for objects that failed the inspection.

The identification information that is input to the processing device 220 may be different from the identification information that is read from the image signal as long as the transferred object can be identified. In the example described here, the product code that is assigned to each object is read from the image signal; and the information of the barcode of the object is input to the processing device 220.

Advantages of the embodiment will now be described.

There are cases where a transfer device that can automatically transfer an object is used in a work site such as a logistics warehouse, etc. When a logistics warehouse is newly built, the logistics warehouse can be optimized to introduce industrial robots; and robots can efficiently perform work by complete automation. On the other hand, there are several problems when introducing robots to an existing site in which work is performed manually. For example, when an industrial robot replaces manual work, a safety fence must be installed around the industrial robot so that a person does not enter. Modifications also are necessary for the robot to cooperate with the peripheral device related to the work.

For these problems, the transfer device 1 includes the collaborative robot 10. As described above, the collaborative robot 10 conforms to various safety standards, and so it is unnecessary to install safety fences or the like. Therefore, a dedicated area for robots is unnecessary. According to an aspect of the embodiment, the transfer device 1 can be easily introduced to an area in which persons work without the need to alter an area to install robots.

According to another aspect of the embodiment, the collaborative robot 10, the first sensor 41, etc., of the transfer device 1 are mounted to the housing 70. The housing 70 is easily moved by a mobile mechanism. The transfer device 1 can be easily moved to the location at which it is desirable for a robot perform the work. Also, it is easy to align the transfer device 1 because the transfer device 1 that is moved is fixed at the prescribed position by the fixture 80. The transfer device 1 can be easily transported and installed at an area in which persons work.

The wheels 71 may be used as the mobile mechanism, or another mechanism may be used. For example, the housing 70 may be movable by buoyancy by the mobile mechanism forcing air downward.

The inspection device 50 and/or the display device 60 may be configured to be detachable from the housing 70 as long as the inspection device 50 and the display device 60 are movable together with the housing 70. For example, when moving the transfer device 1, the inspection device 50 is configured to be movable together with the housing 70 by installing the inspection device 50 at a prescribed position with respect to the collaborative robot 10 and by fixing the inspection device 50 to the housing 70. The inspection device 50 may be configured to be movable by itself by mounting wheels to the inspection device 50. The inspection device 50 may be mounted to the transfer device 1 later.

According to another aspect of the embodiment, the processing device 33 of the transfer device 1 acquires information included in an image signal and transmits a signal corresponding to the transfer result of the collaborative robot 10. Because the transfer device 1 includes the processing device 33, the transfer device 1 can replace the transmission of information that had been performed by a person using a device. Because the processing device 33 transmits the information to other transfer devices, it is unnecessary to perform modifications for the robot to cooperate with peripheral devices related to the work. Therefore, the robot can easily perform work performed by persons.

It is favorable for the transfer device 1 to include the second sensor 42. When the second sensor 42 detects a person proximate to the transfer device 1, the robot controller 32 slows the operation of the collaborative robot 10 or stops the operation of the collaborative robot 10. As described above, the collaborative robot 10 includes safety functions. Although the collaborative robot 10 has sufficient safety if the collaborative robot 10 conforms to safety standards, the safety can be further increased by including the second sensor 42. For example, the danger of a person at the periphery being injured by the transfer device 1 can be sufficiently reduced even when the transfer device 1 is installed in an area in which persons work at the periphery.

For example, the range of movement of the collaborative robot 10 is preset in the spatial coordinate system of the collaborative robot 10. The range of movement includes the range in which the collaborative robot 10 can move in the transfer operation and the range in which the collaborative robot 10 can move in the change operation of the fixture 80. When a person is detected by the control device 31, the gripping tool 20 determines whether or not the person is within the range of movement. When the person is within the range of movement, the gripping tool 20 reduces the operation speed of the collaborative robot 10 or stops the collaborative robot 10. Subsequently, when the person is determined not to be within the range of movement, the gripping tool 20 operates the collaborative robot 10 at normal speed.

As shown in FIG. 1, it is favorable for the transfer device 1 to include the inspection device 50. When the inspection device 50 is included, the object that is transferred by the collaborative robot 10 can be inspected to confirm whether or not the object matches the prescribed object. For example, an object inspection in which a person checks with the naked eye also can be replaced with the transfer device 1. The accuracy of the transfer work by the transfer device 1 can be improved.

The failed objects that are transferred to the prescribed location as a result of the inspection are subsequently inspected collectively by a person and contained in a prescribed storage location. The transferring by the transfer device 1 can be continued without stopping even when the inspection result is a failure, and so the ratio of utilization of the transfer device 1 can be increased. For example, the manager of the work site can move the transfer device 1 to the necessary position and cause the transfer device 1 to perform the processing described above.

It is favorable for the gripping tool 20 to be detachable from the distal end of the collaborative robot 10. In the housing 70, one or more gripping tools 20 are held by the tool pockets 25. In such a case, the collaborative robot 10 can change the gripping tool 20 according to the object to be gripped. The collaborative robot 10 can grip more diverse objects by changing the gripping tool 20.

It is also favorable to fix the base 11 and the tool pocket 25 of the collaborative robot 10 with respect to the housing 70. In such a case, the positional relationship between the collaborative robot 10 and the tool pocket 25 is fixed. Even when the transfer device 1 is moved, the positional relationship between the collaborative robot 10 and the tool pocket 25 does not change. In other words, even when the transfer device 1 is moved, the position of the gripping tool 20 held by the tool pocket 25 is fixed in the spatial coordinate system of the collaborative robot 10. Therefore, even when the transfer device 1 is moved, it is unnecessary to newly specify the coordinates of the gripping tool 20 in the collaborative robot 10. The convenience of the transfer device 1 can be further improved.

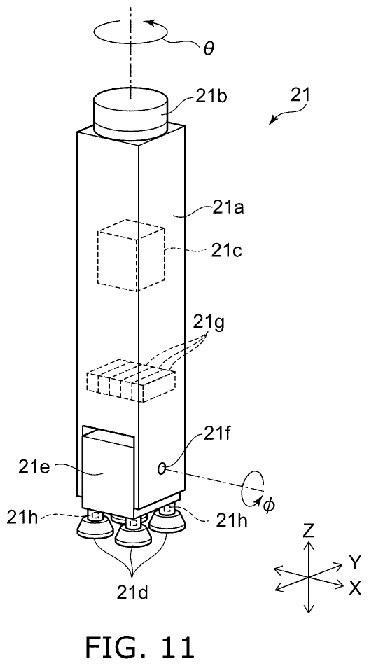

FIGS. 11 to 13 are schematic views showing an example of a gripping tool.

For example, the gripping tool 21 shown in FIG. 11 is used as the gripping tool 20. The gripping tool 21 grips the object by suction-gripping. As shown in FIG. 11, the gripping tool 21 includes a base 21a, a rotation axis 21b, a suction device 21c, a suction pad 21d, a support part 21e, a rotation axis 21f, switch valves 21g, and a pressure sensor 21h.

The base 21a has a rectangular parallelepiped exterior shape and forms the contour of the gripping tool 21. The base 21a is coupled to the collaborative robot 10 via the rotation axis 21b. The rotation axis 21b rotatably couples the base 21a to the collaborative robot 10. The axial direction of the rotation axis 21b is substantially parallel to a Z-direction that connects the base 21a and the distal part of the collaborative robot 10. The rotation axis 21b includes a motor and can rotate the base 21a with respect to the collaborative robot 10 in a θ-direction and the opposite direction of the θ-direction.

The suction device 21c is located inside the base 21a. The suction device 21c is, for example, a vacuum pump. The suction device 21c communicates with the multiple suction pads 21d via hoses, etc. By driving the suction device 21c, the pressure inside each suction pad 21d drops below atmospheric pressure; and the object is suction-gripped by the suction pads 21d.

The support part 21e is coupled to the distal part of the base 21a via the rotation axis 21f. The axial direction of the rotation axis 21f is substantially perpendicular to the Z-direction. For example, the axial direction of the rotation axis 21f is perpendicular to the axial direction of the rotation axis 21b. The rotation axis 21f includes a motor and can rotate the support part 21e with respect to the base 21a in a ϕ-direction and the opposite direction of the ϕ-direction.

The support part 21e supports the multiple suction pads 21d. Each suction pad 21d has an opening; and the opening contacts the object when gripping. The suction pad 21d is flexible and can deform along the surface shape of the object. One end of the suction pad 21d is connected to a tube; and the other end of the suction pad 21d is open toward the side opposite to the support part 21e. The multiple suction pads 21d are arranged along two directions crossing each other. In the illustrated example, a total of four suction pads 21d are arranged to be two in the X-direction and two in the Y-direction. The X-direction and the Y-direction are perpendicular to the Z-direction and orthogonal to each other. The orientations of the multiple suction pads 21d are changed by operations of the rotation axis 21b or the rotation axis 21f.

The multiple switch valves 21g are provided respectively for the multiple suction pads 21d. Each switch valve 21g is set to the suction state or the release state. In the suction state, the suction device 21c communicates with the corresponding suction pad 21d. The internal pressure of the suction pad 21d is regulated by the suction device 21c. In the release state, the suction pad 21d and the suction device 21c are cut off from each other; and the suction pad 21d communicates with the outside of the gripping tool 21 (an atmospheric pressure space). For example, the number of the switch valves 21g set to the suction state is adjusted according to the size of the object to be gripped.

The pressure inside the suction pad 21d is detected by the pressure sensor 21h. A negative pressure sensor can be used as the pressure sensor 21h. For example, the multiple pressure sensors 21h respectively measure the pressures inside the multiple suction pads 21d.

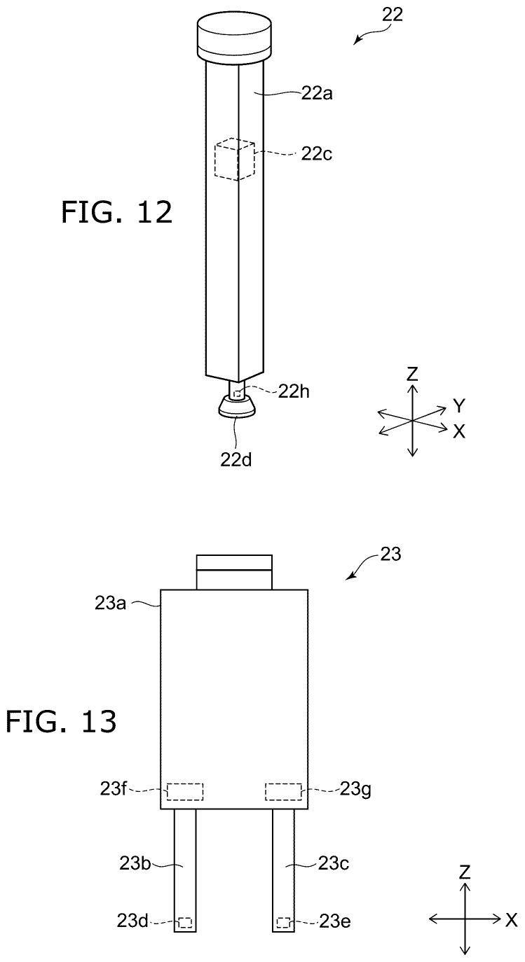

FIG. 12 is a perspective view showing another example of a gripping tool.

The gripping tool 22 shown in FIG. 12 may be used as the gripping tool 20. Similarly to the gripping tool 21, the gripping tool 22 grips the object by suction-gripping. However, the structure of the gripping tool 22 is different from the structure of the gripping tool 21. As shown in FIG. 12, the gripping tool 22 includes a base 22a, a suction device 22c, a suction pad 22d, and a pressure sensor 22h.

Similarly to the base 21a, the base 22a forms the contour of the gripping tool 22. The base 22a is fixed with respect to the distal part of the collaborative robot 10. The suction device 22c is located inside the base 21a and can exhaust the interior of the suction pad 21d. The suction pad 22d is fixed with respect to the base 22a. The gripping tool 22 does not include a rotation axis, and so the orientation of the suction pad 22d with respect to the distal part of the collaborative robot 10 is fixed. The pressure sensor 22h detects the pressure inside the suction pad 22d.

The gripping tool 22 differs from the gripping tool 21 in that the rotation axis is not included. In other words, the gripping tool 22 does not include a motor. Also, the gripping tool 22 includes only one suction pad 22d. Therefore, only one pressure sensor 22h is included, and a switch valve is not included.

FIG. 13 is a perspective view showing another example of a gripping tool.

The gripping tool 23 shown in FIG. 13 may be used as the gripping tool 20. The gripping tool 23 grips the object by pinching. The gripping tool 23 includes a base 23a, a support part 23b, a support part 23c, a sensor 23d, a sensor 23e, a motor 23f, and a motor 23g.

The base 23a forms the contour of the gripping tool 23. The base 23a is fixed with respect to the distal part of the collaborative robot 10. The support part 23b and the support part 23c are mounted to the base 23a. The support part 23b and the support part 23c are plate-shaped or rod-shaped and extend along the Z-direction. Other than the illustrated example, the gripping tool 23 may include a structure that includes three or more support parts.

The sensor 23d and the sensor 23e are located respectively at the distal ends of the support parts 23b and 23c. The support part 23b and the support part 23c are elastic in the Z-direction. When the support part 23b deforms in the Z-direction, the sensor 23d detects the deformation amount. When the support part 23c deforms in the Z-direction, the sensor 23e detects the deformation amount. For example, the sensor 23d and the sensor 23e each include a linear pulse encoder, a force sensor, a strain sensor, or a laser displacement meter.

The support part 23b and the support part 23c are separated from each other in the X-direction. The motor 23f and the motor 23g respectively drive the support part 23b and the support part 23c along the X-direction. The distance between the support part 23b and the support part 23c is changed by the operations of the motors 23f and 23g. In other words, the support part 23b and the support part 23c are opened and closed by the motor 23f and the motor 23g.

Favorable processing by the transfer device 1 will now be described.

The generation of the transfer plan by the control device 31 includes recognizing the object, calculating the coordinates of the object, calculating the gripping point, etc. The gripping point is the position of the gripping tool 20 when the object is gripped. When the gripping tool 20 grips an object by suction, the gripping point corresponds to the position of the center of one or more suction pads. When the gripping tool 20 grips the object by pinching, the gripping point corresponds to the position of the center of the multiple support parts.

The control device 31 calculates the gripping points for the gripping tools 20 that can be used by the collaborative robot 10. Then, the control device 31 calculates the safety factor for each gripping point. The safety factor indicates the likelihood of being able to transfer the object without dropping the object. The likelihood of dropping the object during the transfer decreases as the safety factor increases. The control device 31 weights the safety factor according to whether or not a gripping tool is mounted to the collaborative robot 10. The gripping tool 20 mounted to the collaborative robot 10 is given a weighting that is greater than the weighting of the gripping tool 20 not mounted to the collaborative robot 10. After weighting, the control device 31 compares each safety factor to a preset threshold. The control device 31 selects the gripping tool 20 having the highest safety factor from among the safety factors that are greater than the threshold.

For example, a calculation technique of the safety factor when suction is used for gripping is discussed in paragraphs 0061 to 0096 of JP-A 2021-037608 (Kokai), etc. A method for calculating the safety factor when pinching is used for gripping is discussed in paragraphs 0052 to 0107 of JP-A 2021-146434 (Kokai), etc.

The collaborative robot 10 does not change the gripping tool 20 when the selected gripping tool 20 is already mounted to the collaborative robot 10. The collaborative robot 10 changes the mounted gripping tool 20 to the selected gripping tool 20 when the selected gripping tool 20 is different from the gripping tool 20 mounted to the collaborative robot 10. By setting the weighting of the gripping tool 20 mounted to the collaborative robot 10 to be greater than the weighting of the gripping tool 20 not mounted, the change frequency of the gripping tool 20 can be suppressed, and the transfer efficiency of the collaborative robot 10 can be increased.

When the gripping point is determined, the control device 31 calculates the movement path of the collaborative robot 10 to the gripping point, the movement path of the collaborative robot 10 after gripping the object at the gripping point, etc. A transfer plan that includes the gripping point and the movement paths is generated thereby.

After the collaborative robot 10 grips the object, the collaborative robot 10 may standby while gripping the object until the mobile body 210 is standing by at the prescribed position. When the object is placed on the inspection device 50, the object is transferred by the inspection device 50 and discharged. If the mobile body 210 is not standing by at the discharge destination of the object at this time, the object falls from the inspection device 50. The processing device 33 acquires information from the processing device 220 on whether or not the mobile body 210 is standing by at the position of the discharge destination, and transmits the information to the control device 31. When the mobile body 210 is standing by at the prescribed position, the collaborative robot 10 places the object on the inspection device 50. When the mobile body 210 is not standing by at the prescribed position, the collaborative robot 10 waits without placing the object on the inspection device 50.

When the gripping by the collaborative robot 10 fails, the control device 31 re-performs the calculation of the gripping point, the generation of the transfer plan, etc. The calculation of the gripping point, the generation of the transfer plan, etc., are repeated until the number of retries reaches a preset number.

The collaborative robot 10 stops the transfer operation when the number of retries reaches the prescribed number, when the highest safety factor is not more than the threshold, or when the transfer fails due to an error during the transfer. Errors include unintended contact between the collaborative robot 10 and the object during the transfer, dropped objects, system crashes, etc. The control device 31 transmits, to the processing device 33, information related to the collaborative robot 10 and a notification of the end of the transfer operation. The information related to the collaborative robot 10 includes information such as whether or not the collaborative robot 10 is gripping an object, the state of the collaborative robot 10 before gripping, etc.

When an error occurs, the control device 31 may perform processing to automatically recover from the error state. For example, when an object is dropped, the control device 31 may re-generate a transfer plan to transfer another object. When a system crash occurs, the control device 31 may initialize the system and re-generate the transfer plan. If the collaborative robot 10 was gripping an object when the error occurred, the object is placed on the inspection device 50 and transferred toward the mobile body 210. The mobile body 210 transfers the object to the container in which objects determined to have failed are collected.

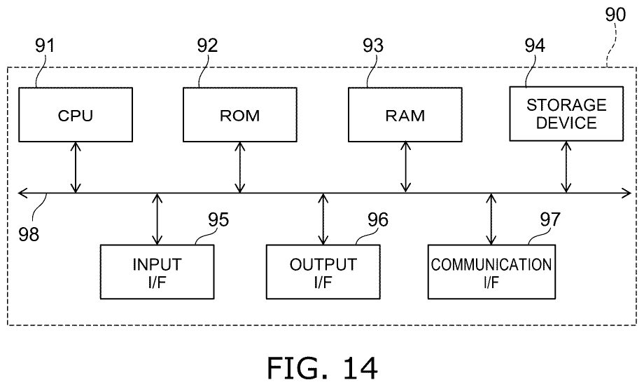

FIG. 14 is a schematic view illustrating a hardware configuration.

For example, the control device 31, the robot controller 32, and the processing device 33 each include a computer 90 shown in FIG. 14. The computer 90 includes a CPU 91, ROM 92, RAM 93, a storage device 94, an input interface 95, an output interface 96, and a communication interface 97.

The ROM 92 stores programs controlling operations of the computer 90. The ROM 92 stores programs necessary for causing the computer 90 to realize the processing described above. The RAM 93 functions as a memory region into which the programs stored in the ROM 92 are loaded.

The CPU 91 includes a processing circuit. The CPU 91 uses the RAM 93 as work memory to execute the programs stored in at least one of the ROM 92 or the storage device 94. When executing the programs, the CPU 91 executes various processing by controlling configurations via a system bus 98.

The storage device 94 stores data necessary for executing the programs and/or data obtained by executing the programs. The storage device 94 includes at least one selected from a hard disk drive (HDD) and a solid state drive (SSD).

The input interface (I/F) 95 can connect the computer 90 and an input device. The input I/F 95 is, for example, a serial bus interface such as USB, etc. The CPU 91 can read various data from the input device via the input I/F 95.

The output interface (I/F) 96 can connect the computer 90 and an output device. The output I/F 96 is, for example, an image output interface such as Digital Visual Interface (DVI), High-Definition Multimedia Interface (HDMI (registered trademark)), etc. The CPU 91 can transmit data to the output device via the output I/F 96 and cause the output device to display an image.

The communication interface (I/F) 97 can connect the computer 90 and a server outside the computer 90. The communication I/F 97 is, for example, a network card such as a LAN card, etc. The CPU 91 can read various data from the server via the communication I/F 97.

The processing performed by the control device 31, the robot controller 32, or the processing device 33 may be realized by one computer 90 or may be realized by collaboration of multiple computers 90.

The processing of the various data described above may be recorded, as a program that can be executed by a computer, in a magnetic disk (a flexible disk, a hard disk, etc.), an optical disk (CD-ROM, CD-R, CD-RW, DVD-ROM, DVD±R, DVD±RW, etc.), semiconductor memory, or another non-transitory computer-readable storage medium.

For example, the information that is recorded in the recording medium can be read by a computer (or an embedded system). The recording format (the storage format) of the recording medium is arbitrary. For example, the computer reads a program from the recording medium and causes a CPU to execute the instructions recited in the program based on the program. In the computer, the acquisition (or the reading) of the program may be performed via a network.

Embodiments of the invention include the following features.

### Feature 1

A transfer device, including:
a collaborative robot configured to transfer an object; and
a first sensor configured to detect the object;
a housing to which the collaborative robot and the first sensor are mounted, the housing being movable by a mobile mechanism; and
a fixture mounted to the housing, the fixture being configured to fix the housing.

### Feature 2

The transfer device according to feature 1, further including:
a second sensor mounted to the housing, the second sensor being configured to detect a person at a periphery of the collaborative robot.

### Feature 3

The transfer device according to feature 1 or 2, further including:
a processing device configured to
   acquire information included in an image signal, and
   transmit an input signal corresponding to a transfer result of the collaborative robot.

### Feature 4

The transfer device according to any one of features 1 to 3, further including:
an inspection device mounted to the housing,
the inspection device being configured to inspect the object transferred by the collaborative robot.

### Feature 5

The transfer device according to feature 4, in which
the inspection device includes:
   a detection part configured to detect a weight of the object; and
   a transfer part configured to transfer, to a prescribed position, the object transferred by the collaborative robot, and
the inspection device is configured to detect the weight of the object transferred by the transfer part.

### Feature 6

The transfer device according to feature 2, in which
the first sensor includes an imaging device configured to image the object, and
the second sensor includes a distance sensor.

### Feature 7

The transfer device according to any one of features 1 to 6, in which
a gripping tool is detachably mounted to a distal end of the collaborative robot, and
one or more of the gripping tools is mounted to the housing.

### Feature 8

The transfer device according to feature 7, in which
a holder is located at the housing,
the holder is configured to hold the gripping tool, and
a positional relationship between the collaborative robot and the holder is fixed.

### Feature 9

The transfer device according to any one of features 1 to 8, in which
the fixture is fixed by engaging a mating member, and
the mating member is prescribed.

### Feature 10

A transfer device, including:
a collaborative robot configured to transfer an object;
a control device configured to control the collaborative robot;
a first sensor configured to detect the object;
a second sensor configured to detect a person at a periphery of the collaborative robot; and
a processing device configured to
   acquire information included in an image signal, and
   transmit a signal corresponding to a transfer result of the collaborative robot.

### Feature 11

A transfer system, including:
the transfer device according to feature 3 or 10;
a first transfer system configured to transfer the object to a position at which the collaborative robot can grip the object; and
a second transfer system configured to transfer, to another location, the object transferred by the collaborative robot.

### Feature 12

The transfer system according to feature 11, in which
the transfer device further includes an inspection device configured to inspect the object transferred by the collaborative robot, and
the second transfer system is configured to transfer the object to a location corresponding to an inspection result of the object.

### Feature 13

The transfer system according to feature 11 or 12, in which
the first transfer system includes:
   a first display device; and
   a first processing device configured to transmit an image signal to the first display device,
the second transfer system includes:
   a second display device; and
   a second processing device configured to transmit an image signal to the second display device,
the image signal from the first processing device includes identification information of an object to be gripped, and
the processing device is configured to:
   acquire, before gripping by the collaborative robot, the identification information from the image signal transmitted from the first processing device to the first display device; and
   transmit, to the second processing device after transferring by the collaborative robot, an input signal corresponding to a transfer result.

### Feature 14

A processing device, configured to:
communicate with a first transfer system configured to transfer an object to a position at which a collaborative robot can grip the object; and
communicate with a second transfer system configured to transfer, to another location, the object transferred by the collaborative robot,
the first transfer system including
   a first display device, and
   a first processing device configured to transmit an image signal to the first display device,
the second transfer system including
   a second display device, and
   a second processing device configured to transmit an image signal to the second display device,
the image signal from the first processing device including identification information of an object to be gripped,
the processing device being further configured to:
   acquire, before gripping by the collaborative robot, the identification information from the image signal transmitted from the first processing device to the first display device; and
   transmit, to the second processing device after transferring by the collaborative robot, an input signal corresponding to a transfer result.

### Feature 15

A processing method, including:
causing a processing device to communicate with a first transfer system and a second transfer system, the first transfer system being configured to transfer an object to a position at which a collaborative robot can grip the object, the second transfer system being configured to transfer, to another location, the object transferred by the collaborative robot,
the first transfer system including
   a first display device, and
   a first processing device configured to transmit, to the first display device, an image signal including identification information of an object to be gripped,
the second transfer system including a second processing device,
the processing method further including causing the processing device to
   acquire, before gripping by the collaborative robot, the identification information from the image signal transmitted from the first processing device to the first display device, and
   transmit, to the second processing device after transferring by the collaborative robot, an input signal corresponding to a transfer result.

### Feature 16

A processing device, configured to:
perform the processing method according to feature 15.

### Feature 17

A program,
the program, when executed by a processing device, causing the processing device to perform the processing method according to feature 15.

### Feature 18

A storage medium, configured to:
store the program according to feature 17.

The embodiments above provide a transfer device, a transfer system, a processing method, a processing device, a program, and a storage medium that are easy to introduce to a site in which manual work is performed.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention. Moreover, above-mentioned embodiments can be combined mutually and can be carried out.

What is claimed is:

1. A transfer device, comprising:
a collaborative robot configured to transfer an object; and
a first sensor configured to detect the object;
a housing to which the collaborative robot and the first sensor are mounted, the housing being movable by a mobile mechanism; and
a fixture mounted to the housing, the fixture being configured to fix the housing.

2. The transfer device according to claim 1, further comprising:
a second sensor mounted to the housing, the second sensor being configured to detect a person at a periphery of the collaborative robot.

3. The transfer device according to claim 1, further comprising:
a processing device configured to
acquire information included in an image signal, and
transmit an input signal corresponding to a transfer result of the collaborative robot.

4. The transfer device according to claim 1, further comprising:
an inspection device mounted to the housing,
the inspection device being configured to inspect the object transferred by the collaborative robot.

5. The transfer device according to claim 4, wherein
the inspection device includes:
a detection part configured to detect a weight of the object; and
a transfer part configured to transfer, to a prescribed position, the object transferred by the collaborative robot, and
the inspection device is configured to detect the weight of the object transferred by the transfer part.

6. The transfer device according to claim 2, wherein
the first sensor includes an imaging device configured to image the object, and
the second sensor includes a distance sensor.

7. The transfer device according to claim 1, wherein
a gripping tool is detachably mounted to a distal end of the collaborative robot, and
one or more of the gripping tools is mounted to the housing.

8. The transfer device according to claim 7, wherein
a holder is located at the housing,
the holder is configured to hold the gripping tool, and
a positional relationship between the collaborative robot and the holder is fixed.

9. The transfer device according to claim 1, wherein
the fixture is fixed by engaging a mating member, and
the mating member is prescribed.

10. A transfer device, comprising:
a collaborative robot configured to transfer an object;
a control device configured to control the collaborative robot;
a first sensor configured to detect the object;
a second sensor configured to detect a person at a periphery of the collaborative robot; and
a processing device configured to
acquire information included in an image signal, and
transmit a signal corresponding to a transfer result of the collaborative robot.

11. A transfer system, comprising:
the transfer device according to claim 3;
a first transfer system configured to transfer the object to a position at which the collaborative robot can grip the object; and
a second transfer system configured to transfer, to another location, the object transferred by the collaborative robot.

12. The transfer system according to claim 11, wherein
the transfer device further includes an inspection device configured to inspect the object transferred by the collaborative robot, and
the second transfer system is configured to transfer the object to a location corresponding to an inspection result of the object.

13. The transfer system according to claim 11, wherein
the first transfer system includes:
a first display device; and
a first processing device configured to transmit an image signal to the first display device,
the second transfer system includes:
a second display device; and
a second processing device configured to transmit an image signal to the second display device,
the image signal from the first processing device includes identification information of an object to be gripped, and
the processing device is configured to:
acquire, before gripping by the collaborative robot, the identification information from the image signal transmitted from the first processing device to the first display device; and
transmit, to the second processing device after transferring by the collaborative robot, an input signal corresponding to a transfer result.

14. A processing device, configured to:
communicate with a first transfer system configured to transfer an object to a position at which a collaborative robot can grip the object; and
communicate with a second transfer system configured to transfer, to another location, the object transferred by the collaborative robot,
the first transfer system including
a first display device, and
a first processing device configured to transmit an image signal to the first display device,
the second transfer system including
a second display device, and
a second processing device configured to transmit an image signal to the second display device,
the image signal from the first processing device including identification information of an object to be gripped,
the processing device being further configured to:
acquire, before gripping by the collaborative robot, the identification information from the image signal transmitted from the first processing device to the first display device; and
transmit, to the second processing device after transferring by the collaborative robot, an input signal corresponding to a transfer result.

15. A processing method, comprising:
causing a processing device to communicate with a first transfer system and a second transfer system, the first transfer system being configured to transfer an object to a position at which a collaborative robot can grip the object, the second transfer system being configured to transfer, to another location, the object transferred by the collaborative robot,
the first transfer system including
a first display device, and
a first processing device configured to transmit, to the first display device, an image signal including identification information of an object to be gripped,
the second transfer system including a second processing device,
the processing method further comprising causing the processing device to
acquire, before gripping by the collaborative robot, the identification information from the image signal transmitted from the first processing device to the first display device, and
transmit, to the second processing device after transferring by the collaborative robot, an input signal corresponding to a transfer result.

16. A processing device, configured to:
perform the processing method according to claim 15.

17. A non-transitory computer-readable storage medium storing a program,
the program, when executed by a processing device, causing the processing device to perform the processing method according to claim 15.
